(19) United States
(12) Patent Application Publication
(10) Pub. No.: US 2007/0011461 A1
(43) Pub. Date: Jan. 11, 2007

(54) Personal data security system and method for handheld devices

(76) Inventor: Yau-Ren Jeng, Hsin-Tien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/172,785

(22) Filed: Jul. 5, 2005

(51) Int. Cl. H04L 9/00

(52) U.S. Cl. 713/183

(57) ABSTRACT

A personal data security system and method for hand held devices are resolved for only locking all the applications or the personal data at a time, or to not lock a single application/function or port of the information in the hand held device quickly. The hand held device has a locking/unlocking function module to provide a locking function or an unlocking function, to make the locked personal data or the locked applications/functions are not displayed or executed on the hand held device. Via long pressing at least two of the buttons simultaneously or inputting the buttons sequentially executes the locking function and sets one of the secret levels of the applications/functions or the personal data. When user inputting one secret unlocking code is executed the unlocking function to unlock the locked applications/functions or the locked personal data, thereby the hand held device is achieved to the personal data security.

### BACKGROUND OF THE INVENTION

1. Field of the Invention

The present invention relates to a personal data security system for a hand held device, and particularly to a method to fast activate/de-activate a security lock on the personal data and applications/functions in the hand held device via password control and secret level setting.

2. Description of Related Art

Nowadays, compact, convenient and multi-functional hand held devices, such as high-end mobile phone, already play important roles in our jobs and daily life. In addition to voice communication, this kind of devices also provide personal information management, image and video capture, data download. Much personal data are thus store in mobile phones, and the security issues therein are more important.

The traditional mobile phone employs a PIN code to prevent unauthorized user to utilize the phone. They cannot provide different secret levels for the applications or personal data in phone.

### SUMMARY OF THE INVENTION

The present invention provides a personal data security system for a hand held device. This system comprises a locking/unlocking function module which provides locking and unlocking functions to control access states of functions, applications, and data in the device.

The present invention provides a method to fast activate/de-activate a security lock on the personal data and applications/functions in hand held device. The method comprises the following steps. First, receive at least one setting instruction to set secret levels of functions, applications, and data in the device. Then, receive a selection instruction to enable a secret level to execute the locking function. Functions, applications, and data that secret level are equal to (and above) the selected secret level will be locked. To change secret level to higher one, the device is operated by receiving an input password of target secret level.

### BRIEF DESCRIPTION OF THE DRAWINGS

The foregoing aspect aspects and many of the attendant advantage of this invention will be more readily appreciated as the same becomes better understood by reference to the following detailed description, when taken in conjunction with the accompanying drawings, wherein:

FIG. 1 is a block diagram of a personal data security system of a hand held device according to the present invention;

FIG. 2 is a flowchart showing a method to fast activate/de-activate a security lock on the personal data and applications/functions in the hand held device according to a first embodiment of the present invention;

FIG. 3 is a flowchart showing a method to fast activate/de-activate a security lock on the personal data and applications/functions in the hand held device according to a second embodiment of the present invention;

FIG. 4 is a flowchart of a method to fast activate/de-activate a security lock on the personal data and applications/functions in the hand held device via long pressing one of a plurality of buttons according to the present invention; and

FIG. 5 is a flowchart of a method to fast activate/de-activate a security lock on the personal data and applications/functions in the hand held device via simultaneously or sequentially pressing the buttons according to the present invention.

### DETAILED DESCRIPTION OF THE EMBODIMENTS

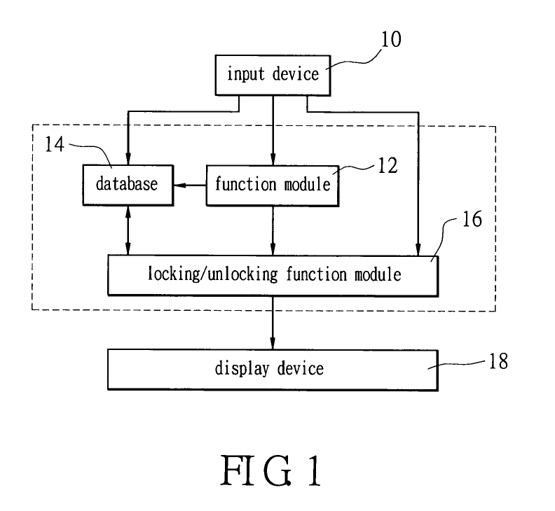

FIG. 1 shows a schematic view of a hand held device having a personal data security system, an input device 10 and a display device 18. The personal data security system includes a function module 12, a database 14 and a locking/unlocking function module 16. The input device 10 has a plurality of buttons for transmitting an input command to the function module 12 and the locking/unlocking function module 16 for transmitting input data to the database 14. The function module 12 provides various kinds of applications for the hand held device. For example, call log, phone book, short message service, calendar and record book, etc. The database 14 is a data storage part of the hand held device. When the locking/unlocking function module 16 is used to execute a locking function to lock personal data or functions/applications, the locked functions/application or personal data will not be executed or displayed on the display device 18. Next, the locking/unlocking function module 16 can use a secret unlocking code to unlock the locked functions/application or personal data.

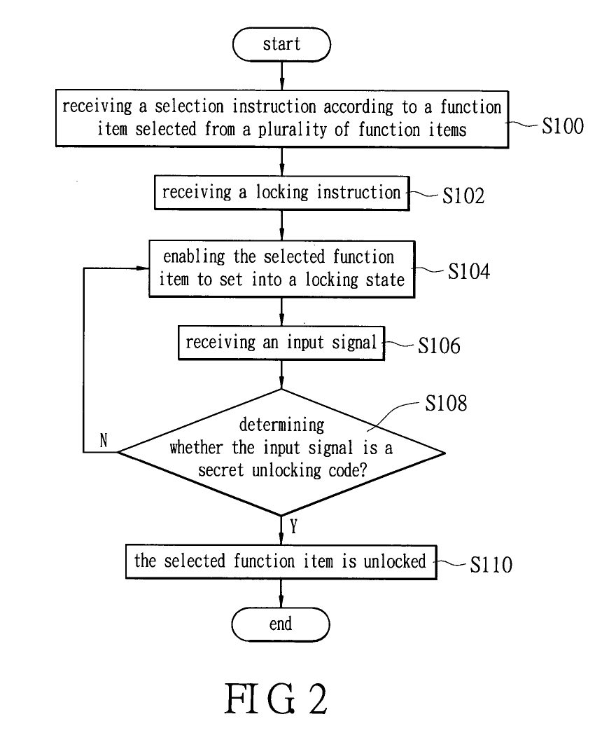

FIG. 2 shows a flowchart of a method to fast activate/de-activate a security lock on the personal data and applications/functions in the hand held device according to a first embodiment of the present invention. The method includes the following steps: receiving a selection instruction of an item selected from a plurality of personal data, application items, and function items (S100); receiving a locking instruction (S102) for enabling the selected function item to set into a locking state (S104); receiving an input password (S106); and determining whether the input password is a secret unlocking code or not (S108); wherein if yes, the selected item is unlocked (S110); and if no, the selected function is continued in the locking state (S104). The items are provided by various kinds of data, applications, and functions in the hand held device, such as call log, phone book, short message service, calendar and record book. In the step of receiving the locking instruction (S102), the locking instruction includes a signal input via simultaneously pressing at least two of a plurality of buttons of input device 10 in a predetermined time or sequentially pressing at the least two of the buttons. In the step (S104), the selected items is not executed or displayed on the hand held device when the selected function item is set in the locked state. In the step (S106), the input password can be provided by at least one button signal. The hand held device can be used to execute the determination step (S108) according to the received input password.

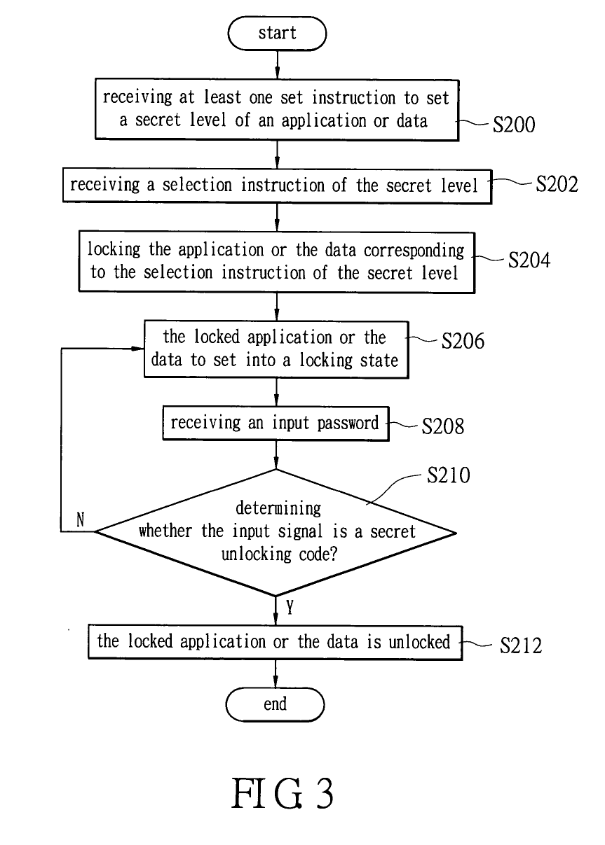

FIG. 3 shows a flowchart of a method to fast activate/de-activate a security lock on the personal data and applications/functions in the hand held device according to a second embodiment of the present invention. The method includes the following steps: receiving at least one set instruction to set a secret level of an item selected from applications, functions, and data (S200); receiving a selection instruction of the secret level (S202); locking the item corresponding to the selection instruction of the secret level (S204); the locked item being set into a locking state (S206); receiving an input password (S208); determining whether the input password is a secret unlocking code or not (S210), and if yes, the locked item is unlocked (S212). The selection instruction of the secret level is executed by a method including: pressing one of a plurality of buttons on the hand held device, so that the display device 14 of the hand held device is provided for displaying a pointer moved among a plurality of secret levels, and then the pointer will indicate one of the secret levels by releasing the button, or by a second method including: simultaneously or sequentially pressing at the least two of the buttons. After the selection instruction is executed, the items of the secret level and the higher secret level will be set in the locking state, thereby not to be executed and displayed on the hand held device. The secret unlocking code with at the least one button signal can be inputted to unlock part or all locked items. The secret unlocking code can be set in the step of receiving the set instruction (S200) or in the step of receiving the selection instruction of the secret level (S202). Further, the user can also input the secret unlocking codes of different secret levels to unlock the items of the secret levels and lower secret levels locked (S212).

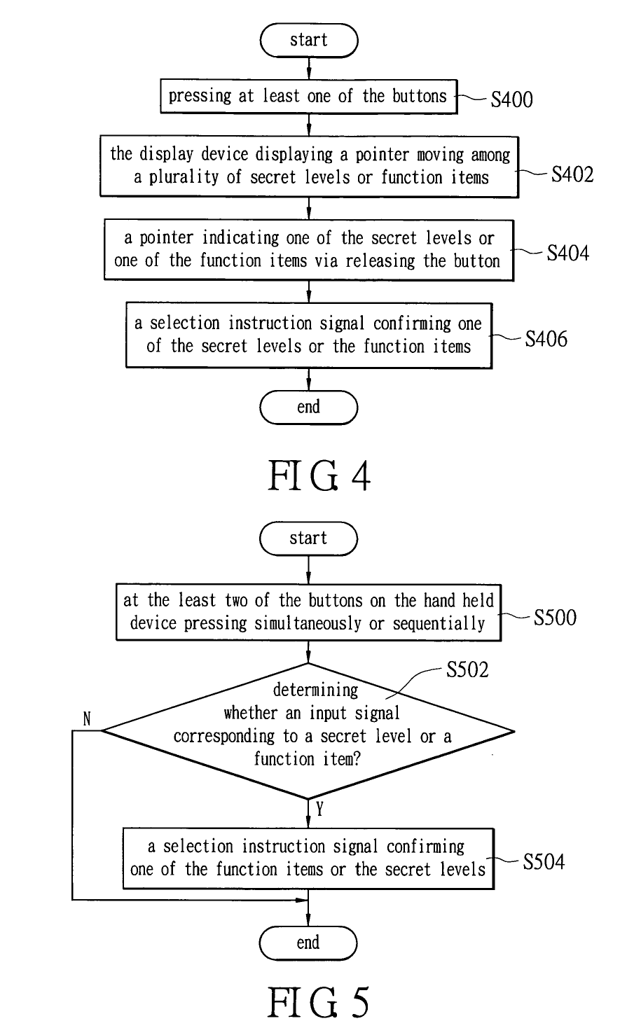

Referring to FIG. 4, a flowchart of a method to fast activate/de-activate a security lock on the personal data and applications/functions in the hand held device via long pressing one of the buttons according the present invention is illustrated. The step of pressing at least one of the buttons (S400) is pressing at least one button of the input device 10 in a predetermined time. The display device 18 is provided for displaying a pointer moved among a plurality of secret levels or items (S402). The pointer indicates one of the secret levels or one of the items via releasing the button (S404), and a selection instruction signal is confirmed for one of the secret levels or the function items (S406). The items are provided by various kinds of applications, functions, and data in the hand held device, such as, call log, phone book, short message service, calendar and record book.

Referring to FIG. 5, a flowchart of a method to fast activate/de-activate a security lock on the personal data and applications/functions in the hand held device via simultaneously or sequentially pressing at least two buttons according to the present invention is illustrated. At the least two of the buttons on the hand held device are pressed simultaneously or sequentially (S500). The hand held device determines whether the signal inputted by the step (S500) corresponds to a secret level or a function item (S502). If the input signal corresponds to the secret level or the function item, a selection instruction signal is confirmed for one of the items or the secret levels (S504). Furthermore, the items are provided by various kinds of applications, functions, and data, for example, call log, phone book, short message service, calendar and record book.

To sum up, the present invention has the following characteristics:

1. The applications/functions and personal data on the hand held device being provided for setting different secret levels;

2. The hand held device is used by long pressing and releasing the lock function button, simultaneously or sequentially pressing buttons to fast lock one of the items comprising functions, the applications and data, or items of the secret level and higher secret level; and

3. The locking/unlocking function module is used for preventing the locked items from being executed or displayed on the hand held device, thereby to provide a data security function.

What is claimed is:

1. A method to fast activate/de-activate a security lock on the personal data and applications/functions in a hand held device, comprising:
receiving a selection instruction of an item selected from a plurality of data, applications, and function;
receiving a locking instruction to lock the selected item;
receiving a composing of input signals; and
determining whether the composing of input signals is a secret unlocking code, wherein if yes, the selected item is unlocked.

2. The method of claim 1, wherein the locking instruction is a signal input via pressing one of a plurality of buttons on the hand held device.

3. The method of claim 1, wherein the locking instruction is a signal input via simultaneously pressing at least two of a plurality of buttons on the hand held device in a predetermined time.

4. The method of claim 1, wherein the locking instruction is a signal input via sequentially pressing at least two of a plurality of buttons on the hand held device.

5. The method of claim 1, wherein the selected item is not executed or displayed on the hand held device when the selected item is locked.

6. The method of claim 1, wherein the input signal is provided by at least one button signal.

7. A method to fast activate/de-activate a security lock on the personal data and applications/functions in a hand held device, comprising:
receiving at least one set instruction to set a secret level of at least one item selected from functions, applications, and data;
receiving a selection instruction of the secret level to lock the least one item;
receiving an input password; and
determining whether the input password is a secret unlocking code, wherein if yes, the locked item is unlocked.

8. The method of claim 7, wherein the selection instruction of the secret level is provided by at least one button signal.

9. The method of claim 7, wherein the selection instruction of the secret level is input via pressing one of a plurality of buttons on the hand held device, a display device of the hand held device is provided for displaying a pointer moved among a plurality of secret levels, and then the pointer indicates one of the secret levels by releasing the button.

10. The method of claim 7, wherein the selection instruction of secret level is input via simultaneously or sequentially pressing at least two of a plurality of buttons on the hand held device.

11. The method of claim 7, wherein the step of receiving the selection instruction is provided for preventing the least one item of the secret level and the higher secret level from being displayed or executed on the hand held device.

12. The method of claim 7, wherein the input signal is provided by at least one button signal.

13. The method of claim 7, wherein the step of receiving at the least one set instruction includes receiving a secret unlocking code.

14. The method of claim 7, wherein the step of receiving the selection instruction includes receiving a secret unlocking code.

15. The method of claim 7, wherein the step of determining includes:
unlocking the locked least one item of the secret level and the lower secret level due to the secret unlocking code of the secret level according to the input password.

16. A personal data security system of a hand held device having an input device and a display device, comprising:
a database; and
a locking/unlocking function module providing a locking function and an unlocking function, and the locking/unlocking function module receiving an instruction of the input device for controlling an access state of the database.

17. The personal data security system of claim 16, wherein the input device of the hand held device has a locking function button to start execution of the locking function via the locking/unlocking function module.

18. The personal data security system of claim 16, wherein the locking/unlocking function module is provided to execute the locking function, so that the locked personal data fail to be displayed on the display device.

19. The personal data security system of claim 18, further comprising a function module connected to the database and the locking/unlocking function module.
